(19) United States
(12) Patent Application Publication
(10) Pub. No.: US 2018/0115398 A1
(43) Pub. Date: Apr. 26, 2018

(54) COORDINATED MULTIPOINT TRANSMISSION AND RECEPTION METHOD AND BASE STATION USING THE SAME

(71) Applicant: INDUSTRIAL TECHNOLOGY RESEARCH INSTITUTE, Hsinchu (TW)

(72) Inventors: Hsuan-Jung SU, Taipei City (TW); Wei-Shun LIAO, New Taipei City (TW); Yu-Cheng LIN, Kaohsiung City (TW); Hsien-Wen CHANG, Hsinchu City (TW)

(21) Appl. No.: 15/385,072

(22) Filed: Dec. 20, 2016

(30) Foreign Application Priority Data
Oct. 21, 2016 (TW) 105134039

(51) Int. Cl. H04L 5/00

(52) U.S. Cl. CPC H04L 5/0035; H04L 5/0048

(57) ABSTRACT

A coordinated multipoint (CoMP) transmission and reception method and a CoMP transmission and reception base station are provided. The CoMP transmission and reception method include the following steps. Forming a plurality of base stations into a CoMP set. Calculating a corresponding Doppler shift value between each of the base stations in the CoMP set and a mobile device respectively. Performing, by each of the base stations in the CoMP set, a Doppler compensation on a reference signal according to the corresponding Doppler shift value to generate a corresponding Doppler compensated reference signal, determining whether a corresponding carrier frequency offset (CFO) value of the corresponding Doppler compensated reference signal is converged, and if all of the CFO values are converged, then each of the base stations in the CoMP set performs a frequency correction according to the corresponding CFO value.

This application claims the benefit of Taiwan application Serial No. 105134039, filed Oct. 21, 2016, the subject matter of which is incorporated herein by reference.

### TECHNICAL FIELD

The disclosure relates in general to a multipoint transmission and reception method and a multipoint transmission and reception base station.

### BACKGROUND

In general, a base station includes an oscillator. Since the oscillating frequencies of the oscillators in different base stations may be different, a carrier frequency offset (CFO) may exist between any two base stations. In the case that a user equipment is served by a single base station, the CFO issue may be solved by the synchronization mechanism in the user equipment. However, in the case that the user equipment is served by a plurality of base stations, for example, in a coordinated multipoint (CoMP) transmission and reception system, it is difficult for the user equipment to use the synchronization mechanism to solve the CFO issues between all of the base stations and/or the user equipment simultaneously. In addition, under a moving environment such as high-speed rail system, a frequency offset induced by Doppler effect may results in poor quality or disconnection for the user equipment to perform wireless communication, and the base stations are difficult to perform the CoMP transmission and reception. Therefore, it becomes a challenge to overcome.

### SUMMARY

The disclosure is directed to a coordinated multipoint (CoMP) transmission and reception method and a CoMP transmission and reception base station.

According to one embodiment, a CoMP transmission and reception method is provided. The CoMP transmission and reception method include the following steps. Forming a plurality of base stations into a CoMP set. Calculating a corresponding Doppler shift value between each of the base stations in the CoMP set and a mobile device respectively. Performing, by each of the base stations in the CoMP set, a Doppler compensation on a reference signal according to the corresponding Doppler shift value to generate a corresponding Doppler compensated reference signal, determining whether a corresponding carrier frequency offset (CFO) value of the corresponding Doppler compensated reference signal is converged, and if all of the CFO values are converged, then each of the base stations in the CoMP set performs a frequency correction according to the corresponding CFO value.

According to another embodiment, a CoMP transmission and reception method is provided. The CoMP transmission and reception method is adaptive to a base station and include the following steps. Obtaining a corresponding Doppler shift value between the base station and a mobile device. Performing a Doppler compensation on a reference signal according to the corresponding Doppler shift value to generate a corresponding Doppler compensated reference signal, determining whether a corresponding carrier frequency offset (CFO) value of the corresponding Doppler compensated reference signal is converged, and if the corresponding CFO value is converged, performing a frequency correction according to the corresponding CFO value.

According to still another embodiment, a CoMP transmission and reception base station is provided. The CoMP transmission and reception base station includes a frequency compensation unit and a CFO estimation and determination unit. The frequency compensation unit is configured to perform a Doppler compensation on a reference signal according to a corresponding Doppler shift value to generate a corresponding Doppler compensated reference signal, and perform a frequency correction according to a corresponding carrier frequency offset (CFO) value if the corresponding CFO value is converged. The CFO estimation and determination unit is configured to determine whether the corresponding CFO value of the corresponding Doppler compensated reference signal is converged.

### BRIEF DESCRIPTION OF THE DRAWINGS

FIG. 1A and FIG. 1B shows a diagram illustrating the CoMP set according to an embodiment of the disclosure.

FIG. 2 shows a block diagram illustrating a central controller 400 according to an embodiment of the disclosure.

FIG. 3A and FIG. 3B shows a block diagram illustrating a base station 500 according to an embodiment of the disclosure.

FIG. 4A shows a flow chart of a CoMP transmission and reception method according to an embodiment of the disclosure.

FIG. 4B shows a flow chart of a CoMP transmission and reception method according to another embodiment of the disclosure.

FIG. 5 shows a flow chart of the CoMP transmission and reception method according to an embodiment of the disclosure.

FIG. 6 shows a flow chart of the Doppler compensation and the frequency correction according to an embodiment of the disclosure.

FIG. 7 shows a flow chart of the Doppler compensation and the frequency correction according to an embodiment of the disclosure.

FIG. 8 shows a flow chart of the Doppler compensation and the frequency correction according to another embodiment of the disclosure.

FIG. 9 shows a flow chart of the Doppler compensation and the frequency correction according to another embodiment of the disclosure.

FIG. 10 shows a CoMP transmission and reception method according to an embodiment of the disclosure.

FIG. 11 shows a CoMP transmission and reception method according to an embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In a wireless communication system, such as Long Term Evolution (LTE) or LTE-Advanced, when a user equipment (UE) such as a mobile device is in a common/overlapped service area of a plurality of base stations, the base stations may perform coordinated multipoint (CoMP) transmission and reception to serve the user equipment. Before performing CoMP transmission and reception, the base stations may be formed into a CoMP set. When the user equipment is under a moving environment (for example, a mobile phone is in a running high-speed rail train), the base stations in the CoMP set may be changed when the user equipment is moving.

Since an oscillating frequency of an oscillator in each of the base stations is different, a carrier frequency offset (CFO) may exist between one base station and another base station. In addition, in a moving environment, Doppler effect may cause additional frequency offset. In an embodiment of the disclosure, a frequency offset includes the CFO and a Doppler shift. The CFO is occurred because of different oscillating frequencies of the oscillators between a base station and another base station/a user equipment. The Doppler shift is generated because of the Doppler effect (for example, a relative movement between a base station and another base station/a user equipment.)

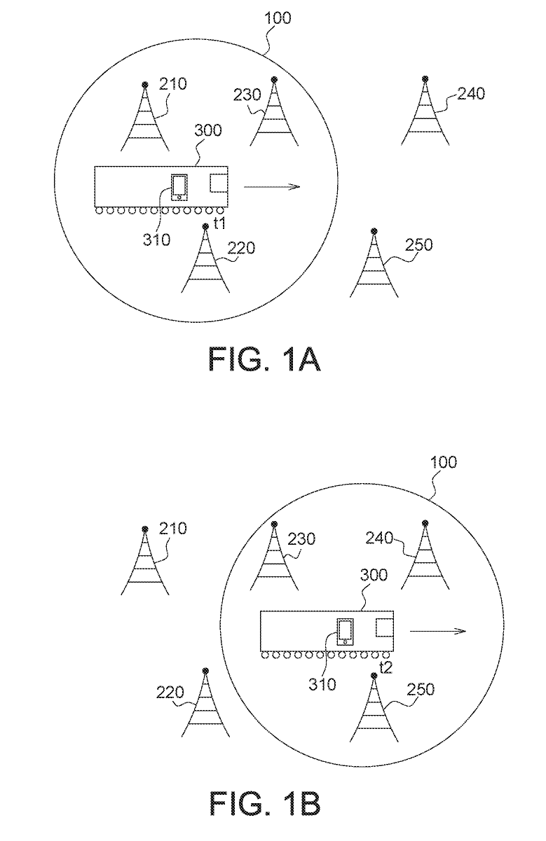

FIG. 1A and FIG. 1B shows a diagram illustrating the CoMP set according to an embodiment of the disclosure. Referring to FIG. 1A and FIG. 1B, a mobile device 310 is in a train 300. As shown in FIG. 1A, at time t1, the train 300 runs into a common/overlapped service area of a first base station 210, a second base station 220, and a third base station 230. Therefore, at time t1, a central control unit (not shown) forms the first base station 210, the second base station 220, and the third base station 230 into a CoMP set 100. In an embodiment, since the train 300 runs along a route of the train 300, the base stations in the CoMP set 100 changes accordingly. As shown in FIG. 1B, at time t2, the train 300 runs into a common/overlapped service area of the third base station 230, a fourth base station 240, and a fifth base station 250. The central control unit removes the first base station 210 and the second base station 220 from the CoMP set 100, and adds the fourth base station 240 and the fifth base station 250 into the CoMP set 100. Therefore, at time t2, the CoMP set 100 includes the third base station 230, the fourth base station 240, and the fifth base station 250. In this embodiment, the mobile device 310 may be a mobile phone, a tablet, a laptop computer, a wearable device, or any device capable of performing wireless communication. The train 300 may be a high-speed rail train, a rail train, a maglev train, a funicular train, or any train or automobile runs along a fixed or predetermined route.

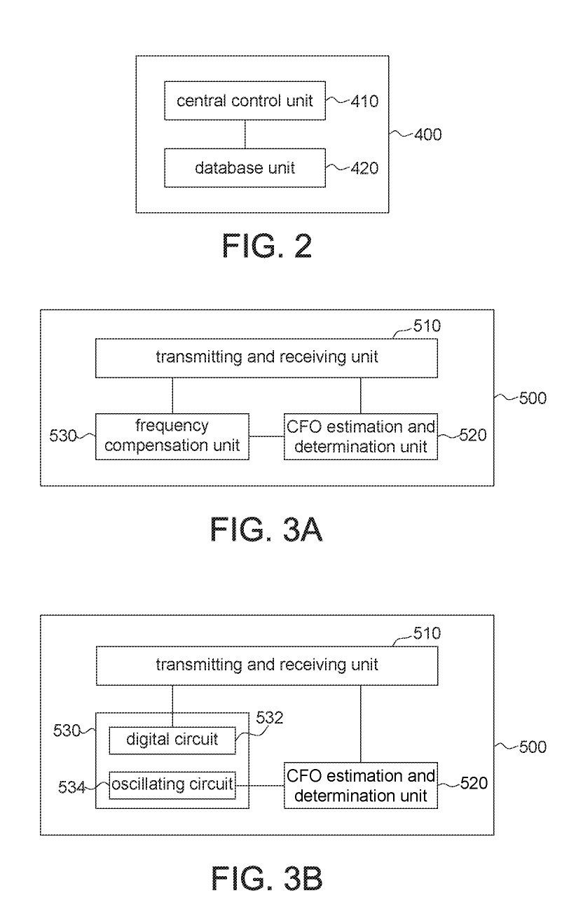

FIG. 2 shows a block diagram illustrating a central controller 400 according to an embodiment of the disclosure. The central controller 400 includes a central control unit 410 and a database unit 420. The central control unit 410 may be coupled to the database unit 420. The central controller 400 may be an independent server. The central controller 400 may be in one or more base station(s). The central controller 400 may also be a server farm of a cloud-radio access network (cloud-RAN). The central control unit 410 and the database unit 420 may also be different devices. For example, the central control unit 410 and the database unit 420 may be in separate servers. In another example, the central control unit 410 and the database unit 420 may be may be in separate base stations or in separate server farm of a cloud-RAN. In an embodiment, the central control unit 410 may be a circuit or a software program executable by a processor (not shown.) The database unit 420 may include a database stored in a memory device (not shown.) The memory device, for example, is a memory, a hard disk drive, or a solid-state drive (SSD). In an embodiment, the database unit 420 may include a circuit or a software program executable by a processor, and a database stored in a memory device.

FIG. 3A and FIG. 3B shows a block diagram illustrating a base station 500 according to an embodiment of the disclosure. Referring to FIG. 3A, the base station 500 includes a transmitting and receiving unit 510, a CFO estimation and determination unit 520, and a frequency compensation unit 530. The transmitting and receiving unit 510 is couple to the CFO estimation and determination unit 520 and the frequency compensation unit 530. The CFO estimation and determination unit 520 is coupled to the frequency compensation unit 530. The transmitting and receiving unit 510 may be a circuit capable of performing wireless communication. The CFO estimation and determination unit 520 may be a circuit or a software program executable by a processor (not shown.) The base station 500 may be the first base station 210, the second base station 220, the third base station 230, the fourth base station 240, or the fifth base station 250 described in FIG. 1A and FIG. 1B.

Referring to FIG. 3B, the base station 500 includes the transmitting and receiving unit 510, the CFO estimation and determination unit 520, and the frequency compensation unit 530. The frequency compensation unit 530 includes a digital circuit 532 and an oscillating circuit 534. The digital circuit 532 is coupled to the transmitting and receiving unit 510. The oscillating circuit 534 is coupled to the CFO estimation and determination unit 520. The digital circuit 532 may be a digital processing circuit or a baseband circuit. The oscillating circuit 534 may include an oscillator, an analog oscillating circuit, or a digital oscillating circuit. In an embodiment, the digital circuit 532, the oscillating circuit 534, and/or the CFO estimation and determination unit 520 may be integrated in a circuit.

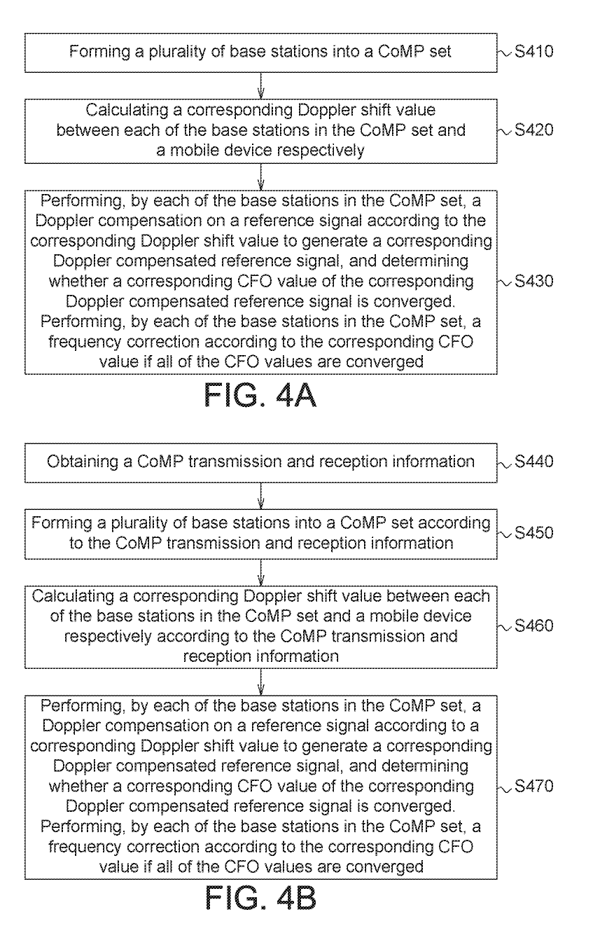

FIG. 4A shows a flow chart of a CoMP transmission and reception method according to an embodiment of the disclosure. Referring to FIG. 1A, FIG. 1B, FIG. 2, and FIG. 4A. The flow chart in FIG. 4A is adapted to a CoMP transmission and reception system. The CoMP transmission and reception system includes a plurality of base stations and at least a mobile device. In an embodiment, the CoMP transmission and reception system may also include a central controller 400 as described in FIG. 2. In the step S410, the central control unit 410 forms a plurality of base stations into a CoMP set 100. For example, at time t1, the central control unit 410 forms the first base station 210, the second base station 220, and the third base station 230 into the CoMP set 100; at time t2, the central control unit 410 forms the third base station 230, the fourth base station 240, and the fifth base station 250 into the CoMP set 100. After the step S410 is performed, the process proceeds to the step S420.

In the step S420, the central control unit 410 calculates a corresponding Doppler shift value between each of the base stations in the CoMP set 100 and a mobile device 310 respectively. For example, at time t1, the central control unit 410 calculates a first Doppler shift value between the first base station 210 and the mobile device 310, a second Doppler shift value between the second base station 220 and the mobile device 310, and a third Doppler shift value between the third base station 230 and the mobile device 310; at time t2, the central control unit 410 calculates the third Doppler shift value between the third base station 230 and the mobile device 310, a fourth Doppler shift value between the fourth base station 240 and the mobile device 310, and a fifth Doppler shift value between the fifth base station 250 and the mobile device 310. Since a relative speed and/or a relative position between the mobile device 310 and the third base station 230 at time t1 and the relative speed and/or the relative position between the mobile device 310 and the third base station 230 at time t2 are different, the calculated third Doppler shift value at time t1 and the calculated third Doppler shift value at time t2 may be different. After the step S420 is performed, the process proceeds to the step S430.

In the step S430, each of the base stations in the CoMP set 100 performs a Doppler compensation on a reference signal according to the corresponding Doppler shift value to generate each of a corresponding Doppler compensated reference signal, and determines whether a corresponding CFO value of the corresponding Doppler compensated reference signal is converged. If all of the CFO values are converged, then each of the base stations in the CoMP set 100 performs a frequency correction according to the corresponding CFO value respectively. For example, at time t1, the first base station 210 performs the Doppler compensation on the reference signal according to the first Doppler shift value to generate a first Doppler compensated reference signal and determines whether a first CFO value of the first Doppler compensated reference signal is converged, the second base station 220 performs the Doppler compensation on the reference signal according to the second Doppler shift value to generate a second Doppler compensated reference signal and determines whether a second CFO value of the second Doppler compensated reference signal is converged, and the third base station 230 performs the Doppler compensation on the reference signal according to the third Doppler shift value to generate a third Doppler compensated reference signal and determines whether a third CFO value of the third Doppler compensated reference signal is converged. If the first CFO value, the second CFO value, and the third CFO value are converged, then the first base station 210 performs the frequency correction according to the first CFO value, the second base station 220 performs the frequency correction according to the second CFO value, and the third base station 230 performs the frequency correction according to the third CFO value. At time t2, the third base station 230 performs the Doppler compensation on the reference signal according to the third Doppler shift value and determines whether a third CFO value of the Doppler compensated reference signal is converged, the fourth base station 240 performs the Doppler compensation on the reference signal according to the fourth Doppler shift value and determines whether a fourth CFO value of the Doppler compensated reference signal is converged, and the fifth base station 250 performs the Doppler compensation on the reference signal according to the fifth Doppler shift value and determines whether a fifth CFO value of the Doppler compensated reference signal is converged. If the third CFO value, the fourth CFO value, and the fifth CFO value are converged, then the third base station 230 performs the frequency correction according to the third CFO value, the fourth base station 240 performs the frequency correction according to the fourth CFO value, and the fifth base station 250 perform the frequency correction according to the fifth CFO value. In an embodiment, each of the base stations in the CoMP set 100 may determine whether the corresponding CFO value of the corresponding Doppler compensated reference signal is converged. Each of the base stations in the CoMP set 100 may transmit the corresponding CFO value to the central control unit 410, and the central control unit 410 determines whether the CFO values are converged. In an embodiment, after one base station in the CoMP set 100 determines that the corresponding CFO value is converged, the base station may perform the frequency correction according to the corresponding CFO value without waiting for notification from the central control unit 410. Later, if the base station receives a notification informed by the central control unit 410 or informed by any of the base stations that the corresponding CFO value in any of the base stations is not converged, then the base station recovers the corrected frequency to an original frequency. In an embodiment, if the corresponding CFO value of each of the base stations in the CoMP set 100 is converged, and after the central control unit 410 determines that all of the CFO values are converged, the central control unit 410 may transmit an notification of frequency correction to each of the base stations in the CoMP set 100 to request each of the base stations in the CoMP set 100 to perform the frequency correction.

In FIG. 4A, the step S410 and the step S420 may be performed in advance or may be performed real-time. For example, which base stations will be formed into the CoMP set 100 may be estimated before time t1, and the Doppler shift values may be calculated in advance. In another example, which base stations would be formed into the CoMP set 100 may be determined at time t1, and then calculating the Doppler shift values.

FIG. 4B shows a flow chart of a CoMP transmission and reception method according to another embodiment of the disclosure. Referring to FIG. 1A, FIG. 1B, FIG. 2, and FIG. 4B. The flow chart in FIG. 4B is adapted to a CoMP transmission and reception system. In the step S440, the central control unit 410 obtains a CoMP transmission and reception information. In an embodiment, the CoMP transmission and reception information include a real-time information and/or a CoMP set information. The mobile device 310 transmits the real-time information to the central control unit 410, and the database unit 420 transmits the CoMP set information to the central control unit 410. In an embodiment, the central control unit 410 may request the real-time information and/or the CoMP set information from the mobile device 310 and/or the database unit 420, and then the mobile device 310 and/or the database unit 420 transmit the real-time information and/or the CoMP set information to the central control unit 410. In an embodiment, the train 300 runs along a fixed or predetermined route and follows a fixed or predetermined timetable. In an embodiment, the CoMP set information may include the timetable of the train 300, a position of the train 300, the route of the train 300, a speed of the train 300, and/or a position of each of the base stations. The CoMP set information may also include a weather information (for example, the temperature or the humidity) or any information useful for the calculation of the frequency offset. In an embodiment, the real-time information may include the position of the train 300 and/or the speed of the train 300. It is noted that since the mobile device 310 is in the train 300, the timetable of the train 300, the position of the train 300, the route of the train 300, and/or the speed of the train 300 may also be considered as a timetable of the mobile device 310, a position of the mobile device 310, a route of the mobile device 310, and/or a speed of the mobile device 310. Both the CoMP set information and the real-time information may include the position of the train 300 and/or the speed of the train 300. In an embodiment, the position of the train 300 and/or the speed of the train 300 included in the CoMP set information is pre-scheduled or is estimated from the timetable of the train 300, while the position of the train 300 and/or the speed of the train 300 included in the real-time information is obtained from global positioning system (GPS) and/or sensor(s). After the step S440 is performed, the process proceeds to the step S450.

In the step S450, the central control unit 410 forms a plurality of base stations into a CoMP set 100 according to the CoMP transmission and reception information. In an embodiment, the central control unit 410 also transmits the CoMP set 100 and/or related information (for example, the base stations included in the CoMP set 100 and all or part of the CoMP transmission and reception information) to the base stations in the CoMP set 100. In an embodiment, the central control unit 410 forms the base stations into the CoMP set 100 according to the timetable of the train 300, the route of the train 300, and/or the position of each of the base stations transmitted from the database unit 420. The description of the step S450 and the description of the step S410 in FIG. 4A may be cross-referenced. After the step S450 is performed, the process proceeds to the step S460.

In the step S460, the central control unit 410 calculates a corresponding Doppler shift value between each of the base stations in the CoMP set 100 and a mobile device 310 respectively according to the CoMP transmission and reception information. In an embodiment, the central control unit 410 calculates the corresponding the Doppler shift value between each of the base stations in the CoMP set 100 and the mobile device 310 respectively according to the route of the train 300 (the route of the mobile device 310), the position of the train 300 (the position of the mobile device 310), the speed of the train 300 (the speed of the mobile device 310) and/or the position of each of the base stations. In an embodiment, according to the position of each of the base stations, the central control unit 410 may also calculate small differences between the Doppler shift values and then determining a compensation order of each of the base stations. For example, at time t1, compensating the first base station 210 firstly, then compensating the second base station 220, and compensating the third base station 230 at last. The description of the step S460 and the description of the step S420 in FIG. 4A may be cross-referenced. After the step S460 is performed, the process proceeds to the step S470.

In the step S470, each of the base stations in the CoMP set 100 performs a Doppler compensation on a reference signal according to the corresponding Doppler shift value to generate a corresponding Doppler compensated reference signal, and determines whether a corresponding CFO value of the corresponding Doppler compensated reference signal is converged. If all of the CFO values are converged, then each of the base stations in the CoMP set 100 performs a frequency correction according to the corresponding CFO value. The description of the step S470 and the description of the step S430 in FIG. 4A may be cross-referenced.

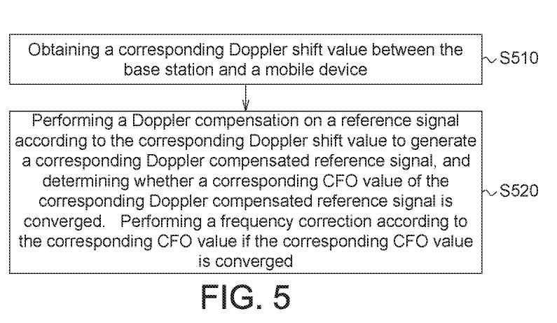

FIG. 5 shows a flow chart of the CoMP transmission and reception method according to an embodiment of the disclosure. Referring to FIG. 1A, FIG. 1B, FIG. 2, FIG. 3A, FIG. 4A, FIG. 4B, and FIG. 5. The flow chart of FIG. 5 may be adaptive to any of the base stations in the CoMP set 100. For example, at time t1, the flow may be applied to the first base station 210, the second base station 220, and/or the third base station 230. At time t2, the flow may be applied to the third base station 230, the fourth base station 240, and/or the fifth base station 250.

In the step S510, the CFO estimation and determination unit 520 obtains a corresponding Doppler shift value between the base station and a mobile device 310. In an embodiment, the corresponding Doppler shift value is a Doppler shift value between the base station 500 and the mobile device 310, and the first base station 210 may be used as an example of the base station 500. The corresponding Doppler shift value is the Doppler shift value between the first base station 210 and the mobile device 310. In an embodiment, the corresponding Doppler shift value may be calculated by the central control unit 410 of the central controller 400 and transmitted to the base station 500. The transmitting and receiving unit 510 of the base station 500 receives the corresponding Doppler shift value and sends the corresponding Doppler shift value to the CFO estimation and determination unit 520 of the base station 500. In an embodiment, the corresponding Doppler shift value may be calculated by the base station 500. The description of the step S510 and the description of the step S420 in FIG. 4A may be cross-referenced. After the step S510 is performed, the process proceeds to the step S520.

In the step S520, the frequency compensation unit 530 performs a Doppler compensation on a reference signal according to the corresponding Doppler shift value to generate a corresponding Doppler compensated reference signal, and the CFO estimation and determination unit 520 determines whether a corresponding CFO value of the corresponding Doppler compensated reference signal is converged. If the corresponding CFO value is converged, the frequency compensation unit 530 performs a frequency correction according to the corresponding CFO value. The description of the step S520, the description of the step S430 and the step S470 in FIG. 4A may be cross-referenced.

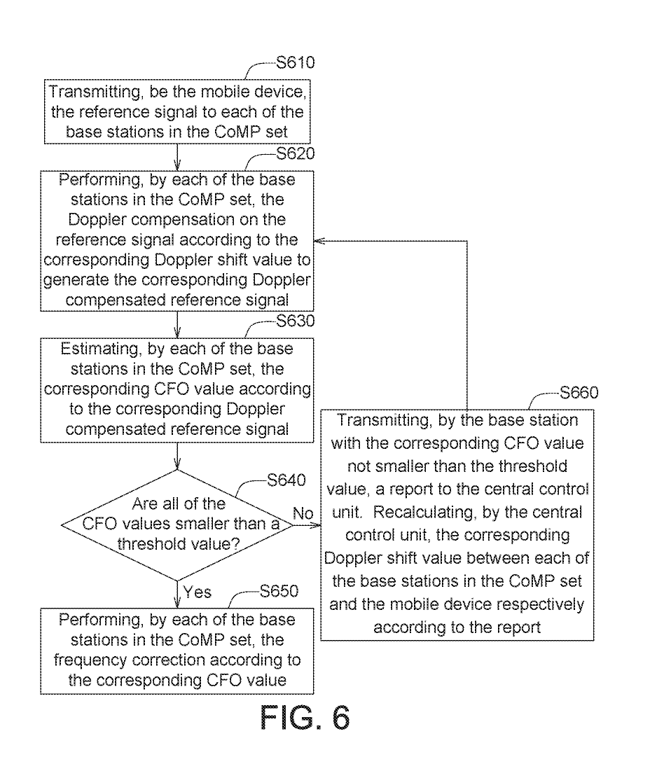

FIG. 6 shows a flow chart of the Doppler compensation and the frequency correction according to an embodiment of the disclosure. The flow chart of FIG. 6 may be adapted to a CoMP transmission and reception system. The flow chart of FIG. 6 may also be a detailed flow of the step S430 in FIG. 4A and the step S470 in FIG. 4B. Referring to FIG. 1A, FIG. 1B, FIG. 2, FIG. 4A and FIG. 4B, and FIG. 6. At time t1, for example, when the mobile device 310 enters the service area of the CoMP set 100 formed by the first base station 210, the second base station 220, and the third base station 230, each of the base stations in the CoMP set 100 and/or the mobile device 310 performs the frequency synchronization according to each of the Doppler shift values respectively. The frequency synchronization may be performed in way of a Doppler compensation and a frequency correction. In this embodiment, the process of the Doppler compensation and the frequency correction is initiated by the mobile device 310. In the step S610, the mobile device 310 transmits the reference signal to each of the base stations in the CoMP set 100. In other words, each of the base stations in the CoMP set 100 receives the reference signal transmitted from the mobile device 310. At time t1, for example, the mobile device 310 transmits the reference signal to the first base station 210, the second base station 220, and the third base station 230. The reference signal may be a pre-defined signal. For example, the reference signal may be a signal whose amplitude is always one. After being modulated, the reference signal becomes a sine wave signal. When the modulated reference signal is received by each of the base stations, each of the received reference signals contains a corresponding frequency offset because of CFO and Doppler shift. In an embodiment, before the step S610 is performed, the central control unit 410 transmits the corresponding Doppler shift value calculated in the step S420 or in the step S460 to each of the base stations in the CoMP set 100 respectively. In an embodiment, before the step S610 is performed, each of the base stations in the CoMP set 100 calculates the corresponding Doppler shift value. After the step S610 is performed, the process proceeds to the step S620.

In the step S620, each of the base stations in the CoMP set 100 performs the Doppler compensation on the reference signal according to the corresponding Doppler shift value to generate the corresponding Doppler compensated reference signal In an embodiment, the Doppler compensation is performed by decreasing the frequency of the base station as the mobile device 310 is moving closer to the base station and increasing the frequency of the base station as the mobile device 310 is moving further from the base station. The Doppler compensation may be performed by digital signal processing such as a baseband circuit in the base station or a signal processing circuit. The Doppler compensation may be performed only on resource block(s) used by each of the base stations and the mobile device 310 respectively, such that the communication between each of the base stations and other user equipment is not influenced. For example, at time t1, the first base station 210 receives the reference signal and performs the Doppler compensation on the reference signal according to the first Doppler shift value, the second base station 220 receives the reference signal and performs the Doppler compensation on the reference signal according to the second Doppler shift value, and the third base station 230 receives the reference signal and performs the Doppler compensation on the reference signal according to the third Doppler shift value. The compensated reference signals are the first Doppler compensated reference signal, the second Doppler compensated reference signal and the third Doppler compensated reference signal, respectively. In detail, for example, an original frequency in the first base station 210 is fₒ₁(t) and the received reference signal includes a frequency offset −f_{d1}(t), such that the frequency of the received reference signal is fₒ₁(t)−f_{d1}(t). The first Doppler shift value is −f_{ds1}(t), and the first base station 210 performs the Doppler compensation on the received reference signal, such that the frequency of the Doppler compensated reference signal f_{dc1}(t) is fₒ₁(t)−f_{d1}(t)+f_{ds1}(t), wherein t means time and f means frequency. Therefore, after performing the Doppler compensation, the Doppler compensated frequency of the first base station 210 is f_{dc1}(t). The description of the Doppler compensated frequencies of the second base station 220 and the third base station 230 are similar to the description of the Doppler compensated frequency of the first base station 210. After the step S620 is performed, the process proceeds to the step S630.

In the step S630, each of the base stations in the CoMP set 100 estimates the corresponding CFO value according to the corresponding Doppler compensated reference signal. At time t1, for example, the first base station 210 estimates the first CFO value according to the first Doppler compensated reference signal, the second base station 220 estimates the second CFO value according to the second Doppler compensated reference signal, and the third base station 230 estimates the third CFO value according to the third Doppler compensated reference signal. In an embodiment, if one of the Doppler compensated reference signals still contains a frequency offset, then the frequency offset of the Doppler compensated reference signal is deemed as CFO. Maximum likelihood (ML) or maximum a posteriori probability (MAP), for example, may be used to estimate the CFO values. After the step S630 is performed, the process proceeds to the step S640.

In the step S640, each of the base stations in the CoMP set 100 determines whether the corresponding CFO value is converged. In an embodiment, the method for each of the base stations in the CoMP set 100 to determine whether the corresponding CFO value is converged is to determine whether the corresponding CFO value is smaller than a threshold value. The threshold value, for example, may be determined by measuring the bit error rate (BER) or the maximum segment size (MSS) in the whole system. At time t1, for example, the first base station 210 determines whether the first CFO value is smaller than the threshold value, the second base station 220 determines whether the second CFO value is smaller than the threshold value, and the third base station 230 determines whether the third CFO value is smaller than the threshold value. In an embodiment, in the step S640, each of the base stations in the CoMP set 100 transmits the corresponding CFO value to the central control unit 410 respectively, and the central control unit 410 determines whether the CFO values are converged (for example, the CFO values are all smaller than the threshold value). If all of the CFO values are converged (for example, the CFO values are all smaller than the threshold value), then the process proceeds to the step S650. If not all of the CFO values are converged, then the process proceeds to the step S660. In other words, if any of the CFO values is not converged, then the process proceeds to the step S660.

If all of the CFO values are converged (smaller than the threshold value), in the step S650, each of the base stations in the CoMP set 100 performs the frequency correction according to the corresponding CFO value. At time t1, for example, the first base station 210 performs the frequency correction according to the first CFO value, the second base station 220 performs the frequency correction according to the second CFO value, and the third base station 230 performs the frequency correction according to the third CFO value. The method of performing frequency correction, for example, is to adjust a frequency of an oscillator in each of the base station or a frequency of an oscillating circuit in each of the base stations. In an embodiment, in the step S640, if the determination of whether all of the CFO values are smaller than the threshold value is performed by the central control unit 410, then the central control unit 410 transmits a frequency correction notification to each of the base stations in the CoMP set 100 before proceeding to the step S650. The frequency correction notification is to request each of the base stations in the CoMP set 100 to perform the frequency correction according to the corresponding CFO value. The method of performing frequency correction is described in detail as follows. In the step S620, the frequency of the Doppler compensated reference signal f_{dc1}(t) is fₒ₁(t)−f_{d1}(t)+f_{ds1}(t). In the step S630, assumed that the first CFO value is −f_{cfo1}(t). Then the first base station 210 performs the frequency correction according to the first CFO value −f_{cfo1}(t). The frequency of the reference signal after performing the frequency correction f_{fc1}(t) is fₒ₁(t)−f_{d1}(t)+f_{ds1}(t)+f_{cfo1}(t). Therefore, after performing the frequency correction, the frequency of the first base station 210 is f_{fc1}(t).

If any of the CFO values is not converged (not smaller than the threshold value), in the step S660, the base station with the corresponding CFO value not smaller than the threshold value transmits a report to the central control unit 410. The report may include a serial number (or identification) of the base station, the corresponding CFO value, whether the corresponding CFO value is converged (smaller than a threshold value), and/or a difference value between the corresponding CFO value and the threshold value. The central control unit 410 recalculates the corresponding Doppler shift value between each of the base stations in the CoMP set 100 and the mobile device 310 respectively according to the report. At time t1, for example, if the second CFO value of the second base station 220 is not converged (not smaller than the threshold value), the second base station 220 transmits the report to the central control unit 410. The central control unit 410 recalculates the first Doppler shift value between the first base station 210 and the mobile device 310, the second Doppler shift value between the second base station 220 and the mobile device 310, and the third Doppler shift value between the third base station 230 and the mobile device 310 respectively according to the report. In an embodiment, if any of the CFO values is not smaller than the threshold value, then the central control unit 410 determines that the position of the train 300 (the mobile device 310) provided by the database unit 420 is different from a real position of the train 300 (the mobile device 310). Therefore, the Doppler shift values are to be recalculated. Interpolation or extrapolation, for example, may be used to redetermine the position of the train 300 (the mobile device 310), and the Doppler shift values are recalculated according to the redetermined position of the train 300 (the mobile device 310). In an embodiment, if the determination that whether all of the CFO values are smaller than the threshold value is performed by the central control unit 410 in the step S640, then the process of transmitting the reported in the step S660 may be omitted and the central control unit 410 may recalculate the corresponding Doppler shift value between each of the base stations in the CoMP set 100 and the mobile device 310 without the report. After recalculating the Doppler shift values, the process returns to the step S620. Each of the base stations in the CoMP set 100 performs the Doppler compensation on the reference signal according to the corresponding Doppler shift values. Since each of the base stations may store the reference signal in a buffer or a memory device (for example, a memory, a hard disk drive, or a SSD), the process does not need to return to the step S610 for the mobile device 310 to retransmit the reference signal. In another embodiment, after recalculating the Doppler shift values, the process returns to the step S610 for the mobile device 310 retransmits the reference signal (not shown). In this case, each of the base stations does not need to store the reference signal in a buffer or a memory device.

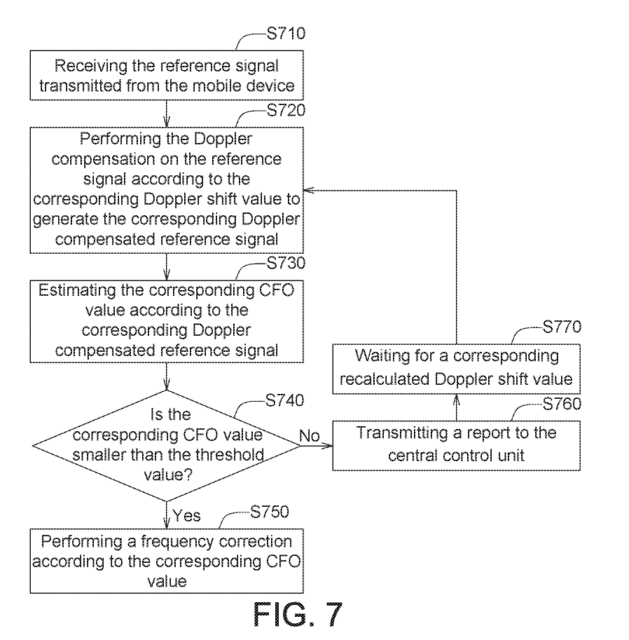

FIG. 7 shows a flow chart of the Doppler compensation and the frequency correction according to an embodiment of the disclosure. The flow chart of FIG. 7 may also be a detailed flow of step S520 in FIG. 5. Referring to FIG. 1A, FIG. 1B, FIG. 3A, FIG. 3B, FIG. 5, FIG. 6, and FIG. 7. The flow chart of FIG. 7 may be adapted to any of the base stations in the CoMP set 100. For example, at time t1, the flow may be applied to the first base station 210, the second base station 220, and/or the third base station 230. At time t2, the flow may be applied to the third base station 230, the fourth base station 240 and/or the fifth base station 250. In this embodiment, the Doppler compensation and the frequency correction is initiated by the mobile device 310.

In the step S710, the transmitting and receiving unit 510 receives the reference signal transmitted from the mobile device 310. The description of the step S710 and the description of the step S610 in FIG. 6 may be cross-referenced. After the step S710 is performed, the process proceeds to the step S720.

In the step S720, the digital circuit 532 performs the Doppler compensation on the reference signal according to the corresponding Doppler shift value to generate the corresponding Doppler compensated reference signal. The description of the step S720 and the description of the step S620 in FIG. 6 may be cross-referenced. After the step S720 is performed, the process proceeds to step the S730.

In the step S730, the CFO estimation and determination unit 520 estimates the corresponding CFO value according to the corresponding Doppler compensated reference signal. The description of the step S730 and the description of the step S630 in FIG. 6 may be cross-referenced. After the step S730 is performed, the process proceeds to step the S740.

In the step S730, the CFO estimation and determination unit 520 determines whether the corresponding CFO value is converged. In an embodiment, the method for the CFO estimation and determination unit 520 to determine whether the corresponding CFO value is converged is to determine whether the corresponding CFO value is smaller than a threshold value. If the CFO estimation and determination unit 520 determines that the CFO value is converged (smaller than the threshold value), then the process proceeds to the step S750. If the CFO estimation and determination unit 520 determines that the CFO value is not converged (not smaller than the threshold value), then the process proceeds to the step S760. The description of the step S740 and the description of the step S640 in FIG. 6 may be cross-referenced.

If the CFO estimation and determination unit 520 determines that the corresponding CFO value is converged (smaller than the threshold value), in the step S750, the oscillating circuit 534 performs a frequency correction according to the corresponding CFO value. In an embodiment, the oscillating circuit 534 generates an oscillating frequency. The performing of the frequency correction, for example, is to adjust the oscillating frequency of the oscillating circuit 534. The description of the step S750 and the description of the step S650 in FIG. 6 may be cross-referenced.

If the CFO estimation and determination unit 520 determines that the corresponding CFO value is not converged (not smaller than the threshold value), in the step S760, the transmitting and receiving unit 510 transmits a report to the central control unit 410. After the step S760 is performed, the process proceeds to the step S770. In the step S770, the transmitting and receiving unit 510 waits for a corresponding recalculated Doppler shift value. After the step S770 is performed, the process return to the step S720 for the digital circuit 532 to perform the Doppler compensation on the reference signal according to the corresponding recalculated Doppler shift value. Since the base station may store the reference signal in a buffer or a memory device, the process does not need to return to the step S710 for the transmitting and receiving unit 510 to receive the reference signal retransmitted from the mobile device 310. In another embodiment, after the step S770 is performed, the process returns to the step S710 for the transmitting and receiving unit 510 to receive the reference signal retransmitted from the mobile device 310 (not shown). In this embodiment, the base station does not need to store the reference signal in a buffer or a memory device. The description of the step S760 and the step S770 and the description of the step S660 in FIG. 6 may be cross-referenced.

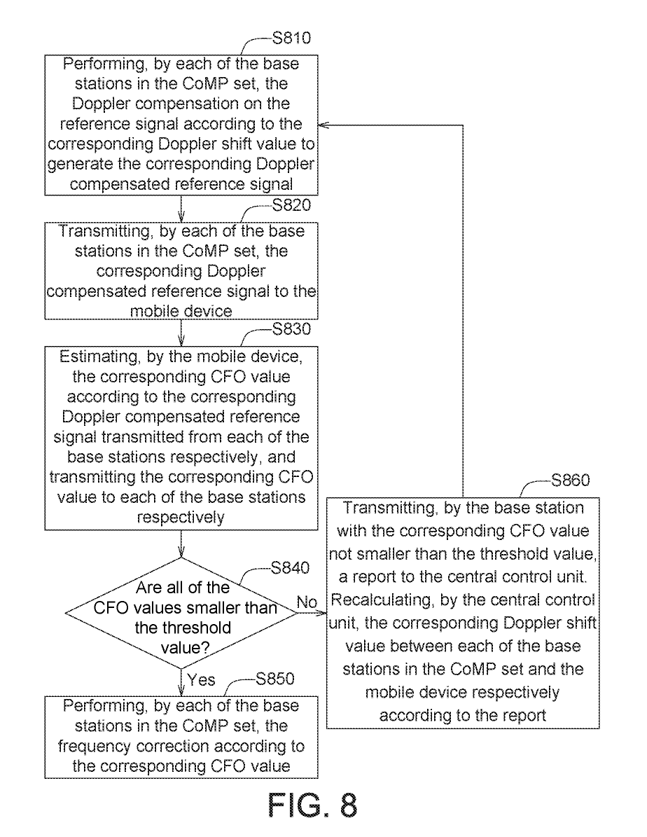

FIG. 8 shows a flow chart of the Doppler compensation and the frequency correction according to another embodiment of the disclosure. The flow chart of FIG. 8 may be adapted to a CoMP transmission and reception system. The flow chart of FIG. 8 may also be a detailed flow of the step S430 in FIG. 4A and the step S470 in FIG. 4B. Referring to FIG. 1A, FIG. 1B, FIG. 2, FIG. 4A, FIG. 4B, FIG. 6, and FIG. 8. At time t1, for example, when the mobile device 310 enters the service area of the CoMP set 100 formed by the first base station 210, the second base station 220, and the third base station 230, each of the base stations in the CoMP set 100 and/or the mobile device 310 performs the frequency synchronization according to the corresponding Doppler shift value. The frequency synchronization may be performed in way of the Doppler compensation and the frequency correction. In this embodiment, the Doppler compensation and frequency correction is initiated by the base stations.

In the step S810, each of the base stations in the CoMP set 100 performs the Doppler compensation on the reference signal according to the corresponding Doppler shift values to generate the corresponding Doppler compensated reference signals. The reference signal may be a pre-defined signal. For example, the reference signal may be a signal whose amplitude is always one. At time t1, for example, the first base station 210 performs the Doppler compensation on the reference signal to generate the first Doppler compensated reference signal, the second base station 220 performs the Doppler compensation on the reference signal to generate the second Doppler compensated reference signal, and the third base station 230 performs the Doppler compensation on the reference signal to generate the third Doppler compensated reference signal. The description of the Doppler compensation may refer to the description of the step S620 in FIG. 6. In an embodiment, before the step S810, the central control unit 410 transmits the corresponding Doppler shift value which is calculated in the step S420 or in the step S460 to each of the base stations in the CoMP set 100 respectively. In another embodiment, before the step S810, each of the base stations in the CoMP set 100 calculates the corresponding Doppler shift value. After the step S810 is performed, the process proceeds to the step S820.

In the step S820, each of the base stations in the CoMP set 100 transmits the corresponding Doppler compensated reference signal to the mobile device 310. At time t1, for example, the first base station 210 transmits the first Doppler compensated reference signal to the mobile device 310, the second base station 220 transmits the second Doppler compensated reference signal to the mobile device 310, and the third base station 230 transmits the third Doppler compensated reference signal to the mobile device 310. In others words, the mobile device 310 receives the first Doppler compensated reference signal, the second Doppler compensated reference signal, and the third Doppler compensated reference signal. In an embodiment, each of the base stations may transmits the corresponding Doppler compensated reference signal to the mobile device 310 at different time points. After the step S820 is performed, the process proceeds to the step S830.

In the step S830, the mobile device 310 estimates the corresponding CFO value according to the corresponding Doppler compensated reference signal transmitted from each of the base stations respectively, and transmits the corresponding CFO value to each of the base stations respectively. For example, the mobile device 310 estimates the first CFO value according to the first Doppler compensated reference signal and transmits the first CFO value to the first base station 210. The mobile device 310 estimates the second CFO value according to the second Doppler compensated reference signal and transmits the second CFO value to the second base station 220. The mobile device 310 estimates the third CFO value according to the third Doppler compensated reference signal and transmits the third CFO value to the third base station 230. The description and the estimation method of the CFO value may refer to the description of the step S630. After the step S830 is performed, the process proceeds to the step S840.

In the step S840, each of the base stations in the CoMP set 100 determines whether the corresponding CFO value is converged. In an embodiment, the method for each of the base stations in the CoMP set 100 to determine whether the corresponding CFO value is converged is to determine whether the corresponding CFO value is smaller than a threshold value. The step S840 is similar to the step S640 in FIG. 6. The description of the step S640 in FIG. 6 may be referenced for the description of the step S840.

If all of the CFO values are converged (smaller than the threshold value), the process proceeds to the step S850. In the step S850, each of the base stations in the CoMP set 100 performs the frequency correction according to the corresponding CFO value. The step S850 is similar to the step S650 in FIG. 6. The description of the step S650 in FIG. 6 may be referenced for the description of the step S850.

If any of the CFO values is not converged (not smaller than the threshold value), then the process proceeds to the step S860. In the step S860, the base station with the corresponding CFO value not smaller than the threshold value transmits a report to the central control unit 410. The central control unit 410 recalculates the corresponding Doppler shift value between each of the base stations in the CoMP set 100 and the mobile device 310 respectively according to the report. The step S860 is similar to the step S660. The description of the step S660 in FIG. 6 may be referenced for the description of the step S860. After the step S860 is performed, the process returns to the step S810, each of the base stations in the CoMP set 100 performs the Doppler compensation on the reference signal according to the corresponding recalculated Doppler shift value.

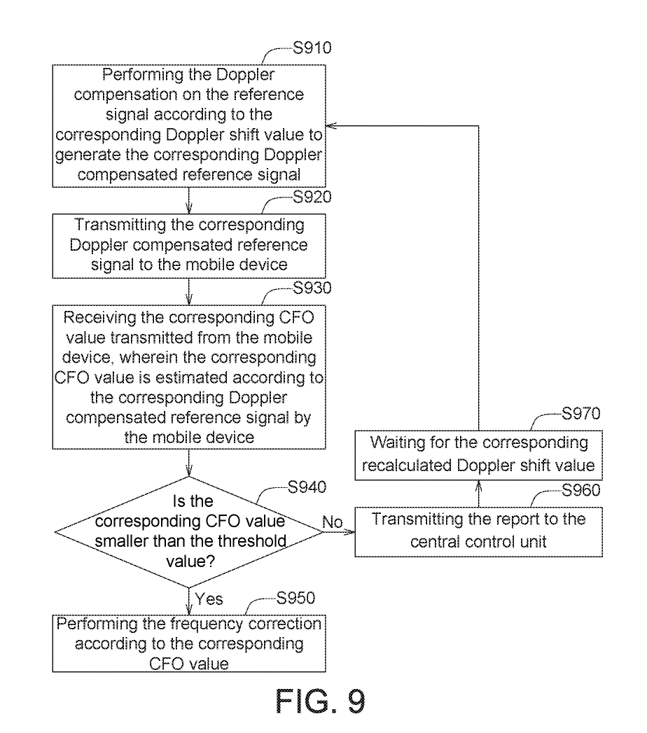

FIG. 9 shows a flow chart of the Doppler compensation and the frequency correction according to another embodiment of the disclosure. The flow chart of FIG. 9 may be a detailed flow of the step S520 in FIG. 5. Referring to FIG. 1A, FIG. 1B, FIG. 3A, FIG. 3B, FIG. 5, FIG. 7, FIG. 8, and FIG. 9. The flow chart of FIG. 7 may be adapted to any of the base stations in the CoMP set 100. For example, at time t1, the flow may be applied to the first base station 210, the second base station 220, and/or the third base station 230. At time t2, the flow may be applied to the third base station 230, the fourth base station 240 and/or the fifth base station 250. In this embodiment, the Doppler compensation and the frequency correction is initiated by the base station.

In the step S910, the digital circuit 532 performs the Doppler compensation on the reference signal according to the corresponding Doppler shift value to generate the corresponding Doppler compensated reference signal. The description of the step S910 and the description of the step S810 in FIG. 8 may be cross-referenced. After the step S910 is performed, the process proceeds to the step S920.

In the step S920, the transmitting and receiving unit 510 transmits the corresponding Doppler compensated reference signal to the mobile device 310. The description of the step S920 and the description of the step S820 in FIG. 8 may be cross-referenced. After the step S920 is performed, the process proceeds to the step S930.

In the step S930, the transmitting and receiving unit 510 receives the corresponding CFO value transmitted from the mobile device 310, wherein the corresponding CFO value is estimated according to the corresponding Doppler compensated reference signal by the mobile device 310. The description of the step S930 and the description of the step S830 in FIG. 8 may be cross-referenced. After the step S930 is performed, the process proceeds to the step S940.

In the step S940, the CFO estimation and determination unit 520 determines whether the corresponding CFO value is converged. In an embodiment, the method for the CFO estimation and determination unit 520 to determine whether the corresponding CFO value is converged is to determine whether the corresponding CFO value is smaller than a threshold value. The step S940 is similar to the step S740 in FIG. 7. The description of the step S740 in FIG. 7 may be referenced for the description of the step S940.

If the CFO estimation and determination unit 520 determines that the corresponding CFO value is converged (smaller than the threshold value), in the step S950, the oscillating circuit 534 performs the frequency correction according to the corresponding CFO value. The step S950 is similar to the step S750 in FIG. 7. The description of the step S750 in FIG. 7 may be referenced for the description of the step S950.

If the CFO estimation and determination unit 520 determines that the corresponding CFO value is not converged (not smaller than the threshold value), in the step S960, the transmitting and receiving unit 510 transmits the report to the central control unit 410. The step S960 is similar to the step S760 in FIG. 7. The description of the step S760 in FIG. 7 may be referenced for the description of the step S960.

In the step S970, the transmitting and receiving unit 510 waits for the corresponding recalculated Doppler shift value. The step S970 is similar to the step S770 in FIG. 7. The description of the step S770 in FIG. 7 may be referenced for the description of the step S970. After the step S970 is performed, the process returns to the step S910 for the digital circuit 532 to perform the Doppler compensation on the reference signal according to the corresponding recalculated Doppler shift value.

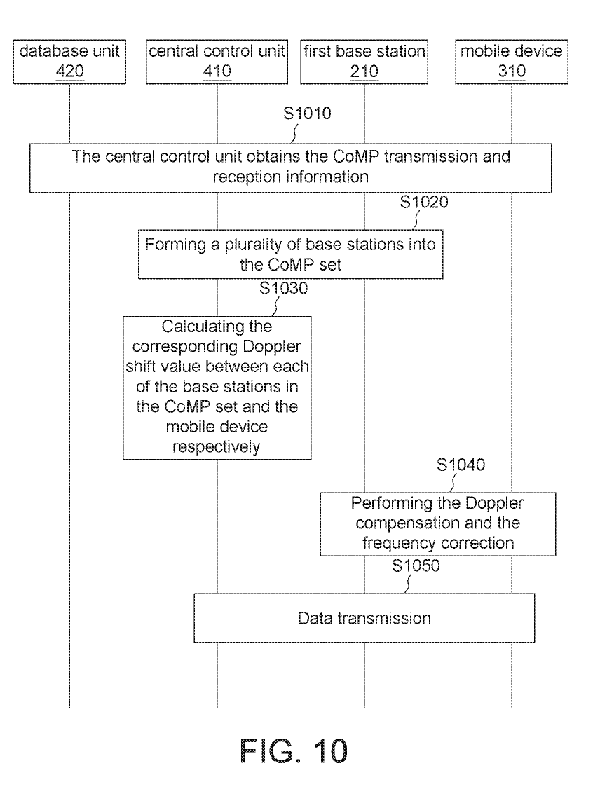

FIG. 10 shows a CoMP transmission and reception method according to an embodiment of the disclosure. In the step S1010, the central control unit 410 obtains the CoMP transmission and reception information. In the step S1020, the central control unit 410 forms a plurality of base stations into the CoMP set. In this embodiment, using the first base station 210 as an example, and the operations of other stations are similar to the first base station 210. In the step S1030, the central control unit 410 calculates the corresponding Doppler shift value between each of the base stations in the CoMP set and the mobile device respectively. In the step S1040, the first base station 210 and the mobile device 310 performs the Doppler compensation and the frequency correction. In the step S1050, the first base station 210 and the mobile device 310 may transmit data to each other.

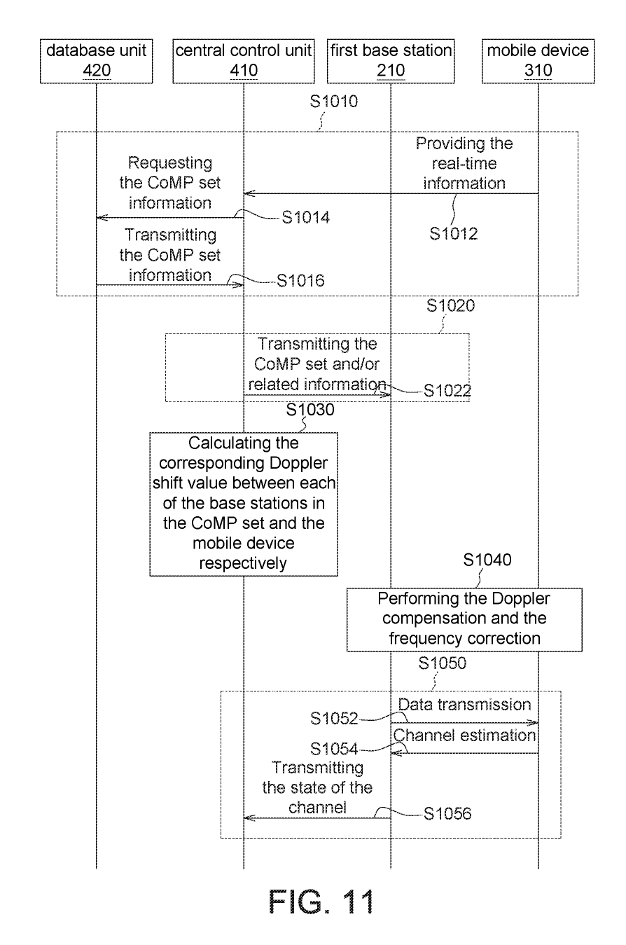

FIG. 11 shows a CoMP transmission and reception method according to an embodiment of the disclosure. Refer to FIG. 10 and FIG. 11. The step S1010 may include the step S1012, the step S1014, and the step S1016. In the step S1012, the mobile device 310 provides the real-time information to the central control unit 410. In the step S1014, the central control unit 410 requests the CoMP set information from the database unit 420. In the step S1016, the database unit 420 transmits the CoMP set information to the central control unit 410. The step S1020 may include the step S1022. After the CoMP set is formed, in the step S1022, the central control unit 410 transmits the CoMP set and/or related information to the first base station 210. The step S1030 and the step S1040 may refer to FIG. 10. The step S1050 may include the step S1052, the step S1054, and the step S1056. In the step S1052, the first base station 210 transmits data to the mobile device 310. In another embodiment, in the step S1052, the mobile device 310 transmits data to the first base station 210. In still another embodiment, the first base station 210 and the mobile device 310 transmit data to each other. In the step S1054, the mobile device 310 performs a channel estimation, and transmits a result of the channel estimation to the first base station 210. The result of the channel estimation may include a state of the channel. In the step S1056, the first base station 210 transmits the state of the channel to the central control unit 410. According to the state of the channel, the central control unit 410 may determine whether the process returns to the step S1010 to redetermine the base stations in the CoMP set.

According to embodiments of the disclosure, in the CoMP transmission and reception system, the train information may be predicted by using the database, and the frequency synchronization and the Doppler compensation between the base stations may be performed according to the predicted information, such that the CoMP transmission and reception may be used by the mobile device under mobile environment.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A coordinated multipoint (CoMP) transmission and reception method, adaptive to a CoMP transmission and reception system, comprising:
forming a plurality of base stations into a CoMP set;
calculating a corresponding Doppler shift value between each of the base stations in the CoMP set and a mobile device respectively; and
performing, by each of the base stations in the CoMP set, a Doppler compensation on a reference signal according to the corresponding Doppler shift value to generate a corresponding Doppler compensated reference signal, determining whether a corresponding carrier frequency offset (CFO) value of the corresponding Doppler compensated reference signal is converged, and if all of the CFO values are converged, then each of the base stations in the CoMP set performs a frequency correction according to the corresponding CFO value.

2. The CoMP transmission and reception method according to claim 1, wherein a central control unit forms the base stations into the CoMP set according to a CoMP transmission and reception information.

3. The CoMP transmission and reception method according to claim 1, wherein a central control unit calculates the corresponding Doppler shift value between each of the base stations in the CoMP set and the mobile device respectively according to a CoMP transmission and reception information.

4. The CoMP transmission and reception method according to claim 3, wherein the mobile device is in a train, the transmission and reception information includes a timetable of the train, a position of the train, a route of the train, a speed of the train, a position of each of the base stations, or a weather information.

5. The CoMP transmission and reception method according to claim 1, wherein the step of performing the Doppler compensation on the reference signal according to the corresponding Doppler shift value to generate the corresponding Doppler compensated reference signal, determining whether the corresponding CFO value of the corresponding Doppler compensated reference signal is converged, and if all of the CFO values are converged, then each of the base stations in the CoMP set performs the frequency correction according to the corresponding CFO value comprises:
receiving, by each of the base stations in the CoMP set, the reference signal transmitted from the mobile device;
performing, by each of the base stations in the CoMP set, the Doppler compensation on the reference signal according to the corresponding Doppler shift value to generate the corresponding Doppler compensated reference signal;
estimating, by each of the base stations in the CoMP set, the corresponding CFO value according to the corresponding Doppler compensated reference signal;
determining, by each of the base stations in the CoMP set, whether the corresponding CFO value is smaller than a threshold value;
if all of the CFO values are smaller than the threshold value,
performing, by each of the base stations in the CoMP set, the frequency correction according to the corresponding CFO value; and
If any of the CFO values is not smaller than the threshold value,
transmitting, by a first base station with a first CFO value not smaller than the threshold value, a report to a central control unit; and
recalculating, by the central control unit, the corresponding Doppler shift value between each of the base stations in the CoMP set and the mobile device respectively according to the report.

6. The CoMP transmission and reception method according to claim 1, wherein the step of performing the Doppler compensation on the reference signal according to the corresponding Doppler shift value to generate the corresponding Doppler compensated reference signal, determining whether the corresponding CFO value of the corresponding Doppler compensated reference signal is converged, and if all of the CFO values are converged, each of the base stations in the CoMP set performs the frequency correction according to the corresponding CFO value comprises:
performing, by each of the base stations in the CoMP set, the Doppler compensation on the reference signal according to the corresponding Doppler shift value to generate the corresponding Doppler compensated reference signals;
transmitting, by each of the base stations in the CoMP set, the corresponding Doppler compensated reference signal to the mobile device;
estimating, by the mobile device, the corresponding CFO value according to the corresponding Doppler compensated reference signal transmitted from each of the base stations respectively, and transmitting the corresponding CFO value to each of the base stations in the CoMP set respectively;
determining, by each of the base stations in the CoMP set, whether the CFO corresponding value is smaller than a threshold value;
if all of the CFO values are smaller than the threshold value,
performing, by each of the base stations in the CoMP set, the frequency correction according to the corresponding CFO value; and
If any of the CFO values is not smaller than the threshold value,
transmitting, by a first base station with a first CFO value not smaller than the threshold value, a report to a central control unit; and
recalculating, by the central control unit, the corresponding Doppler shift value between each of the base stations in the CoMP set and the mobile device respectively according to the report.

7. A coordinated multipoint (CoMP) transmission and reception method, adaptive to a base station, comprising:
obtaining a corresponding Doppler shift value between the base station and a mobile device; and
performing a Doppler compensation on a reference signal according to the corresponding Doppler shift value to generate a corresponding Doppler compensated reference signal, determining whether a corresponding carrier frequency offset (CFO) value of the corresponding Doppler compensated reference signal is converged, and if the corresponding CFO value is converged, performing a frequency correction according to the corresponding CFO value.

8. The CoMP transmission and reception method according to claim 7, wherein the step of performing the Doppler compensation on the reference signal according to the corresponding Doppler shift value to generate the corresponding Doppler compensated reference signal, determining whether the corresponding CFO value of the corresponding Doppler compensated reference signal is converged, and if the corresponding CFO value is converged, performing the frequency correction according to the corresponding CFO value comprises:
performing the Doppler compensation on the reference signal according to the corresponding Doppler shift value to generate the corresponding Doppler compensated reference signal;
estimating the corresponding CFO value according to the corresponding Doppler compensated reference signal;
determining whether the corresponding CFO value is smaller than a threshold value; and
if the corresponding CFO value is smaller than the threshold value, performing the frequency correction according to the corresponding CFO value.

9. The CoMP transmission and reception method according to claim 8, further comprising:
transmitting a report to a central control unit if the corresponding CFO value is not smaller than the threshold value;
waiting for another corresponding Doppler shift value; and
performing the Doppler compensation on the reference signal according to the another corresponding Doppler shift value.

10. The CoMP transmission and reception method according to claim 7, wherein the step of performing the Doppler compensation on the reference signal according to the corresponding Doppler shift value to generate the corresponding Doppler compensated reference signal, determining whether the corresponding CFO value of the corresponding Doppler compensated reference signal is converged, and if the corresponding CFO value is converged, performing the frequency correction according to the corresponding CFO value comprises:
performing the Doppler compensation on the reference signal according to the corresponding Doppler shift value to generate the corresponding Doppler compensated reference signal;
transmitting the corresponding Doppler compensated reference signal to the mobile device;
receiving the corresponding CFO value transmitted from the mobile device, wherein the corresponding CFO value is estimated by the mobile device according to the corresponding Doppler compensated reference signal;
determining whether the corresponding CFO value is smaller than a threshold value; and
performing the frequency correction according to the corresponding CFO value if the corresponding CFO value is smaller than the threshold value.

11. The CoMP transmission and reception method according to claim 10, further comprising:
transmitting a report to a central control unit if the corresponding CFO value is not smaller than the threshold value;
waiting for another corresponding Doppler shift value; and
performing the Doppler compensation on the reference signal according to the another corresponding Doppler shift value.

12. The CoMP transmission and reception method according to claim 7, wherein performing the Doppler compensation on the reference signal by a baseband circuit or a signal processing circuit.

13. The CoMP transmission and reception method according to claim 7, wherein performing the frequency correction by adjusting an oscillating frequency of an oscillating circuit.

14. The CoMP transmission and reception method according to claim 7, wherein the base station receives the corresponding Doppler shift value, and the corresponding Doppler shift value is calculated by a central control unit.

15. The CoMP transmission and reception method according to claim 7, wherein the base station receives the reference signal transmitted from the mobile device.

16. A coordinated multipoint (CoMP) transmission and reception base station, comprising:
a frequency compensation unit, configured to perform a Doppler compensation on a reference signal according to a corresponding Doppler shift value to generate a corresponding Doppler compensated reference signal, and perform a frequency correction according to a corresponding carrier frequency offset (CFO) value if the corresponding CFO value is converged; and
a CFO estimation and determination unit, configured to determine whether the corresponding CFO value of the corresponding Doppler compensated reference signal is converged.

17. The CoMP transmission and reception base station according to claim 16, wherein the CFO estimation and determination unit further configured to estimate the corresponding CFO value according to the corresponding Doppler compensated reference signal and determine whether the corresponding CFO value is smaller than a threshold value, and the frequency compensation unit further configured to perform the frequency correction according to the corresponding CFO value if the corresponding CFO value is smaller than the threshold value.

18. The CoMP transmission and reception base station according to claim 17, further comprising:
a transmitting and receiving unit, configured to transmit a report to a central control unit if the corresponding CFO value is not smaller than the threshold value.

19. The CoMP transmission and reception base station according to claim 17, wherein the frequency compensation unit comprising:
a digital circuit, configured to perform the Doppler compensation on the reference signal according to the corresponding Doppler shift value to generate the corresponding Doppler compensated reference signal; and
an oscillating circuit, configured to generate an oscillating frequency and adjust the oscillating frequency according to the corresponding CFO value.

20. The CoMP transmission and reception base station according to claim 16, wherein the CFO estimation and determination unit further configured to determine whether the corresponding CFO value is smaller than a threshold value, and the frequency compensation unit further configured to perform the frequency correction according to the corresponding CFO value if the corresponding CFO value is smaller than the threshold value, the CoMP transmission and reception base station further comprising:
a transmitting and receiving unit, configured to transmit the corresponding Doppler compensated reference signal to a mobile device and receive the corresponding CFO value transmitted from the mobile device, wherein the corresponding CFO value is estimated by the mobile device according to the corresponding Doppler compensated reference signal.

21. The CoMP transmission and reception base station according to claim 20, wherein the frequency compensation unit comprising:
a digital circuit, configured to perform the corresponding Doppler compensation on the reference signal according to the corresponding Doppler shift value to generate the corresponding Doppler compensated reference signal; and
an oscillating circuit, configured to generate an oscillating frequency and adjust the oscillating frequency according to the corresponding CFO value.
